(19) United States
(12) Patent Application Publication
(10) Pub. No.: US 2011/0246255 A1
(43) Pub. Date: Oct. 6, 2011

(54) SYSTEM AND METHOD FOR ADVANCING MARKETING OPPORTUNITIES TO SALES

(76) Inventors: James Gilbert, Niwot, CO (US); Barry Neu, Longmont, CO (US); Albert A. Prast, Winter Park, FL (US); Peter Antunes, Orlando, FL (US)

(21) Appl. No.: 12/964,533

(22) Filed: Dec. 9, 2010

Related U.S. Application Data
(60) Provisional application No. 61/285,819, filed on Dec. 11, 2009.
(60) Provisional application No. 61/297,657, filed on Jan. 22, 2010.

(51) Int. Cl. G06Q 10/00

(52) U.S. Cl. 705/7.14; 705/7.11

(57) ABSTRACT

A system and method for advancing marketing opportunities to sales is described. One embodiment identifies a plurality of consumer states corresponding to particular situations in a sales lifecycle, one of which corresponds to a completed sale; ascertains one or more correlations among historical sales-lead attributes, product attributes, sales-agent attributes, sales activities, and consumer state transitions; identifies a particular product having a particular set of product attributes; identifies a particular sales lead having a particular set of lead attributes; identifies a particular sales agent having a particular set of agent attributes; identifies one or more particular sales activities; and derives, based on application of the one or more correlations, an estimated probability that a consumer associated with the particular sales lead will transition from one of the plurality of consumer states to another of the plurality of consumer states in relation to the product.

### PRIORITY

The present application claims priority from commonly owned and assigned U.S. Provisional Patent Application Nos. 61/285,819 (Attorney Docket No. CONN-001/00US), filed Dec. 11, 2009, and 61/297,657 (Attorney Docket No. CONN-001/01US), filed Jan. 22, 2010, each of which is entitled “Computer System and Method for Optimizing Acquisition of Consumers,” and each of which is incorporated herein by reference in its entirety and for all purposes.

### FIELD OF THE INVENTION

The present invention relates generally to computerized marketing and sales systems and, more particularly, to a computerized system and method for optimizing acquisition of consumers.

### BACKGROUND OF THE INVENTION

Computer systems employed to acquired and retain customers are known. Conventional systems allow their users to structure marketing campaigns to reach likely consumers of the products and/or services being marketed. In these systems, opportunities for sales or “leads” are identified, evaluated and addressed through a series of organized and tasks and activities structured and sequenced to increase the likelihood that the lead results in a sale. In many sales cycles, a potential consumer of the product or service transitions from a number of “states” from the initial time the lead is known to the consummation of the sale. The process continues after the initial sale or formation of a business relationship, and a similar process is utilized to sell additional products and services to the existing customer and/or to retain the customer—particularly for services offerings or products involving maintenance and support relationships. The process is dynamic as consumer preferences, competition, externalities and a litany of other factors influence the effectiveness of the campaign and the sales approach used to most effectively mature leads into future states and ultimately sales.

To this point, conventional software systems have not aligned the users of the computer systems (i.e., sales agents) with the leads nor optimized and predicted the likelihood that consumers of a particular type or segment will mature from one state to another based on the relevant tasks and activities. Accordingly, there is a need for an effective system and method to address these deficiencies.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

The present invention can provide a system and method for advancing marketing opportunities to sales. One illustrative embodiment is a system for promoting conversion of sales leads into completed sales, the system comprising at least one processor and a memory connected with the at least one processor, the memory containing a plurality of program instructions configured to cause the at least one processor to identify a plurality of consumer states, each consumer state in the plurality of consumer states corresponding to a particular situation in a sales lifecycle, a particular one of the plurality of consumer states corresponding to a completed sale; ascertain one or more correlations among historical sales-lead attributes, product attributes, sales-agent attributes, sales activities, and consumer state transitions; identify a particular product having a particular set of product attributes; identify a particular sales lead having a particular set of lead attributes; identify a particular sales agent having a particular set of agent attributes; identify one or more particular sales activities; and derive, based on application of the one or more correlations to the particular set of product attributes, the particular set of agent attributes, the particular set of lead attributes, and the one or more particular sales activities, an estimated probability that a consumer associated with the particular sales lead will transition from one of the plurality of consumer states to another of the plurality of consumer states in relation to the product.

Another illustrative embodiment is a method for promoting conversion of sales leads into completed sales, the method comprising identifying in a computer memory a plurality of consumer states, each consumer state in the plurality of consumer states corresponding to a particular situation in a sales lifecycle, a particular one of the plurality of consumer states corresponding to a completed sale; using at least one processor connected with the computer memory to ascertain, through a regression analysis, one or more correlations among historical sales-lead attributes, product attributes, sales-agent attributes, sales activities, and consumer state transitions; identifying in the computer memory a particular set of product attributes for a particular product; identifying in the computer memory a particular set of lead attributes for a particular sales lead; identifying in the computer memory a particular set of agent attributes for a particular sales agent; identifying in the computer memory one or more particular sales activities; using the at least one processor to derive, based on application of the one or more correlations to the particular set of product attributes, the particular set of agent attributes, the particular set of lead attributes, and the one or more particular sales activities, an estimated probability that a consumer associated with the particular sales lead will transition from one of the plurality of consumer states to another of the plurality of consumer states in relation to the product; and publishing the estimated probability.

The methods of the invention can also be embodied, at least in part, as executable program instructions stored on a computer-readable storage medium.

These and other embodiments are described in further detail herein.

### BRIEF DESCRIPTION OF THE DRAWINGS

Various objects and advantages and a more complete understanding of the present invention are apparent and more readily appreciated by reference to the following Detailed Description when taken in conjunction with the accompanying Drawings, wherein:

FIG. 1 is a block diagram of a suitable computing system environment for use in implementing various illustrative embodiments of the invention;

FIG. 2 is a flowchart representative of a method for advancing marketing opportunities to sales in accordance with an illustrative embodiment of the invention;

FIG. 3 is a user interface of a computer program illustrating a request for the publication of correlated predictions in response to a query in accordance with an illustrative embodiment of the invention;

FIG. 4 is a user interface of a computer program illustrating the publication of predictions in response to the query submitted via the user interface illustrated in FIG. 3, in accordance with an illustrative embodiment of the invention; and

FIG. 5 is a diagram showing a system for synthesizing data into independent variables that can be used to predict future state transitions in accordance with an illustrative embodiment of the invention.

FIG. 6 is a flowchart depicting a method for advancing marketing opportunities to sales in accordance with another illustrative embodiment of the invention.

### DETAILED DESCRIPTION

The present invention provides a system and method for advancing marketing opportunities to sales.

In one illustrative embodiment, the invention is directed to a method for optimizing the acquisition of a consumer, including initially identifying consumer states in the sales lifecycle. The method also includes accessing lead characteristics from one or more sources of data. The method further includes accessing attributes for a sales campaign, one or more sales activities, one or more sales agents and a product or service being offered to the consumer. The method further includes correlating the attributes and predicting the likelihood of closing the sales (or otherwise advancing the consumer to a higher state), and publishing the predictions in one of a variety of manners.

Another illustrative embodiment of the invention is embodied as one or more computer-readable media having computer-usable components for identifying the states of the sale; accessing lead characteristics from one or more disparate sources of data; accessing attributes for a sales campaign, one or more sales activities, one or more sales agents, and the product or service being offered to the consumer; correlating the attributes and predicting the likelihood of closing the sale.

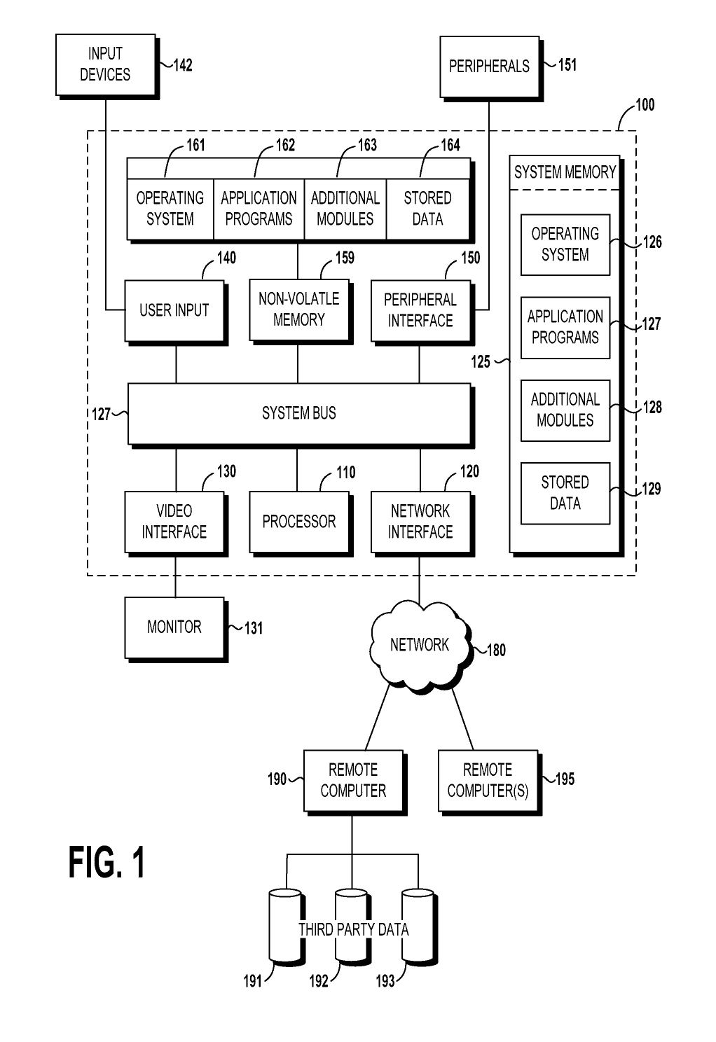

FIG. 1 illustrates an example of a suitable computing system environment in which the invention may be implemented. The computing environment is representative and not limiting to the use and design of the invention. No relationship or interdependency of the elements of the representative operating environment is intended. A number of other specific and general purpose computing environments may be used with the present invention including client-server devices, personal computers, micro-processing devices, virtual machines, cloud computing environments and a variety of centralized and distributed computing environment including one or more of the systems described above or shown in FIG. 1.

The invention is generally set forth in computer-executable instructions in the form of modules or applications being executed by the computer. Known structures are employed and executed across the elements of the computing environment.

With reference to FIG. 1, an exemplary system includes a general purpose computing device in the form of a computer 100. Components of computer 100 include a processor 110, a network interface 120, a system memory 125, and a system bus 127 that couples various system components including the system memory to the processor 110. The system bus 127 may be a memory bus, a peripheral bus, a local bus or a variety of other bus structures.

Computer 100 typically includes a variety of computer readable media. Computer readable media can be any available media that can be accessed by computer 100 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or any other information delivery media. By way of example, and not limitation, communication media includes wired media such as a wired network or direct wired connection, and wireless media such as acoustic, RF, infrared and other wireless media. Combinations of any of the above should also be included within the scope of computer readable media.

The system memory 125 includes computer storage media in the form of volatile and/or nonvolatile memory such as read only memory (ROM) and random access memory (RAM) and a basic input/output system (BIOS) to transfer information between elements within computer 100, that is typically stored in ROM. The RAM typically contains data and/or program modules that are immediately accessible to and/or presently being operated on by processor 110. By way of example, FIG. 1 illustrates an operating system 126, application programs 127, additional modules 128, and stored data 129.

The computer 100 may also include other non-volatile computer storage media 159 which may include non-removable, nonvolatile magnetic media, disk drives, magnetic tape cassettes, flash memory cards, digital video disks, digital video tape, Bernoulli cartridges, solid state RAM, solid state ROM, and the like. The computer storage media discussed above and illustrated in FIG. 1 provide storage of computer readable instructions, data structures, program modules and other data for the computer 100. In FIG. 1, for example, representative memory 159 of nonvolatile memory is illustrated as storing operating system 161, application programs 162, additional program modules 163, and stored data 164. Note that these components can either be the same as or different from operating system 126, application programs 127, additional program modules 128, and stored data 129. A user may enter commands and information into the computer 100 through input devices 142 (i.e., keyboards, mouse, etc.). These and other input devices are often connected to the processor 110 through a user input interface 140 that is coupled to the system bus 127. A monitor 131 or other type of display device is also connected to the system bus 127 via an interface such as a video interface 130. In addition to the monitor 131, computers may also include other peripheral output devices 151 (i.e., a printer), which may be connected through an output peripheral interface 150.

The computer 100 may operate in a networked environment using logical connections to one or more remote computers, such as a remote computers 190 and 195. The remote computers 190, 195 may be a personal computer, a server, a router, a network PC, a peer device or other common network node, and typically includes many or all of the elements described above relative to the computer 100, although only a memory storage device has been illustrated in FIG. 1. The logical connections depicted in FIG. 1 include a network 180 such as a local area network (LAN) or a wide area network (WAN), but may also include other networks. Such networking environments are commonplace in offices, enterprise-wide computer networks, intranets and the Internet. Remote computer 190 may be coupled with a variety of third party data stores 191, 192, 193, as described in greater detail below.

Although many other internal components of the computer 100 are not shown, those of ordinary skill in the art will appreciate that such components and the interconnection are well known. Accordingly, additional details concerning the internal construction of the computer 100 need not be disclosed in connection with the present invention.

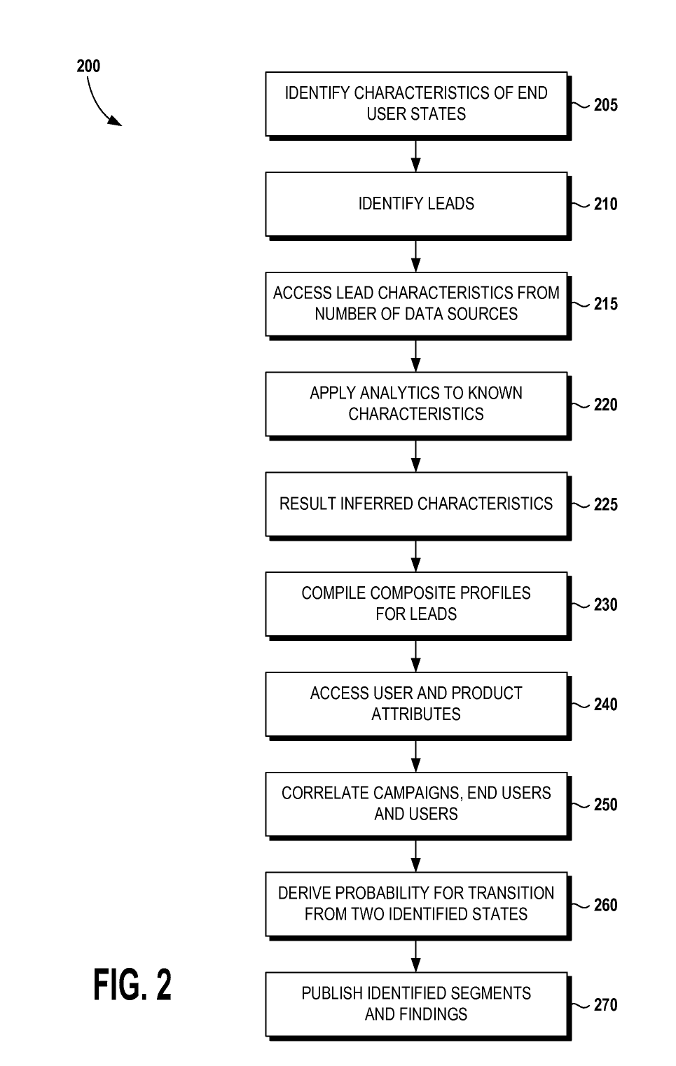

FIG. 2 sets forth a flowchart representative of a method for selectively aligning users of the system with consumers of products and thus selecting the activities to improve the likelihood of progressing the consumer from one state in the sales process to the next state and ultimately to a successful commercial transaction and relationship. The process is identified generally with reference numeral 200.

Initially, at step 205, the characteristics of the various consumer states are identified. In embodiments, each consumer of the product or service progresses through a series of states. One example of a pathway of consumer states includes the following states: (a) an initial interest in the product or service or pre-qualification of a consumer, (b) a transfer of core information regarding the product or service to the consumer, (c) an initial trial of a product or short term enrollment in a service, (d) an initial sale of the product or meaningful provision of the service, (e) an upsale of additional product or services, (f) maintenance and support of the consumer relationship; and (g) retention of the consumer over a period of time. Each consumer state includes a number of characteristics that are stored, for example, as data elements in a referential database such as Stored Data 129. By identifying each of the various states, sales activities may be associated with the consumer state before and after the activity.

Next, at step 210, leads are identified and accessed. A lead is a consumer or business with a qualified interest for a particular product or service. By way of example, leads may be identified by accessing a database containing requests for information about a particularly product or service. In other cases, the core characteristics of the sales and marketing campaign may be applied to qualify (or filter) an initial list of leads. In one example, a particular campaign may be targeted to a specific region (i.e., geography: the Southeast United States), a particular medium (i.e., mode: Internet), a target segment type (i.e., status: families with young children), and target demographics (i.e., income targets: $50,000+, work status: retired, etc.). In such cases, the campaign may be defined by the attributes of the generalized segment targeted by the campaign. The campaign attributes may be applied as an initial pass or filter to the list of leads initially provided so that the qualification process may be complete prior to consumption by the system and methods described herein.

In embodiments, each lead includes one or more attributes of consumer-identifying information including, by way of example, a name or other identifier, a service plan number or product identifier for services/products of stated interest, a phone number or another consumer-specific attribute. The attributes form an initial profile for the consumer lead. Using the attributes obtained at step 210, the system obtains additional attributes for each of the leads at step 215 by accessing available internal data sources such as member directories (if the lead has an existing data set by virtue of prior interactions with the provider of the good or services) or other data acquired. Known systems and methods for merging disparate data sets are employed.

Also, a number of web services (or other data gathering methods) are utilized to access third party data sources in the public domain (such as through network 180 in communication with remote computers 190 and data sources 191, 192, 193). These third party data sources include government records such as real property records, census data, death master lists and the like. The initial lead attributes may be supplemented to include additional demographic profile information such as gender, age and geographic location, and expressed preferences or needs including product-interest, requests to call at specific times, and language preferences.

Next, at step 220, analytics are applied to the known lead characteristics accessed at step 215. In an embodiment, a standardized rule set may be applied to the known attributes to infer and result additional attributes at step 225. By way of example, ZIP code information may be used to access population information and segmentation for attributes such as race, median household income (and income segmentation) and average home value through known web services such as the ESRI GIS information databases. Each of the inferred characteristics is stored as an attribute for the lead. As used herein, inferences may initially result expected values for each consumer, and these inferences may later be validated or adjusted through an iterative process as additional information is known about the lead. Collectively, the known and inferred attributes constitute a lead profile of attributes consumed by the correlative analytics described below.

At step 230, product (or service) attributes, system user (or sales) attributes and activity information attributes are obtained. In an embodiment, product attributes include a product-specific identifier, a price or price range for each product, and the feature(s) found in each product or service. In embodiments, attributes for a number of products are accessed for consumption by the correlative analytics described below.

Likewise, attributes of the sales agent (or system user) are also accessed at step 230. In embodiments, system user attributes include a user identifier, ZIP code, gender, and historical state transition rates between identified states for a number of products and consumer categories. By way of example, the transition rate may include the number of closed or consummated sales for Products A, B, and C for demographic categories (i.e., combination of age and gender), or social categories (i.e., status: soccer moms) or other categories or characteristics of consumers.

Historical activity information attributes include activity data associated with each product and each sales agent. For example, the triggering events (display, search, voice, mailings) and points of contact (toll free number, chart uniform resource indicator (URI), website uniform resource locator (URL), etc.) are included in the sales activity dataset. In embodiments, each activity is defined by the state of the consumer before and after the activity. Collectively, the product, sales agent, and activity information attributes form a dataset that is consumed by the correlative analytics along with the lead profiles described above.

At step 250, correlations are made among attributes of the leads, product/service, sales agent and sales activity. Regression analysis is employed to determine which of the attributes is the best predictor of a successful transition of the lead from one identified state to the next identified state in the sales and retention process. More specifically, in embodiments, the dependent variables in the regression analysis are the state transitions, and the independent variables are each of the various attributes (and combinations therein) of the lead, sales agent, product and sales actions and activities.

Thus, forecasting of the impact on state transitions is conducted and the probability of transitioning a consumer from one state to the next depending on one or more attributes is derived and resulted at step 260. The results of the correlation are predictive and allow the system to optimize and align the sales agents, sales actions and products to improve conversion of the lead to the next state.

As known in the regression analysis, a regression equation is employed and resolved to correlate each of the various attributes to the state transition. In embodiments, regression diagnostics confirm goodness of fit of the regression model to determine the validity of the regression model. For example, in embodiments, the R-squared goodness of fit analysis may be employed. Provided a sufficient goodness of fit, the predictions are validated for purposes of the predictions and sales allocations and adjustments described below. Ultimately, the predictions of step 260 are published to sales agents and campaign managers at step 270 provided the correlations are deemed meaningful.

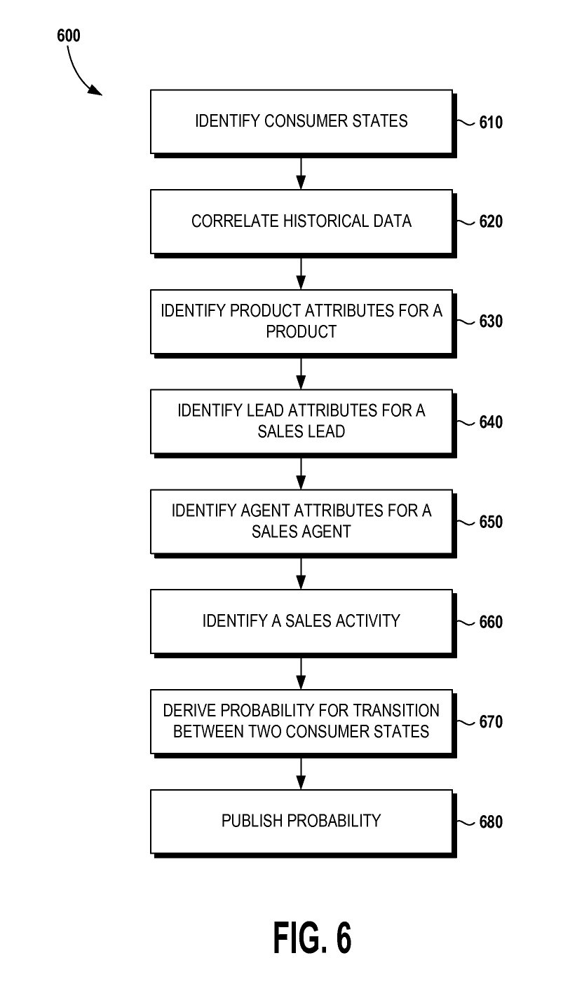

Another illustrative embodiment of the invention is depicted in the flowchart of FIG. 6, which sets forth a method 600 for promoting conversion of sales leads into completed sales. The method 600 begins with step 610, wherein consumer states are identified. Each consumer state corresponds to a particular situation in a sales lifecycle, and one of the consumer states corresponds to a completed sale.

At step 620, known correlative analytics are used to ascertain one or more correlations among historical data, which in embodiments include sales-lead attributes, product attributes, sales-agent attributes, sales activities, and consumer state transitions.

While historical information is consumed at step 620, steps 630, 640, 650, and 660 each involve current information. Specifically, in embodiments the product attributes of a particular product are identified at step 630; the lead attributes of a particular sales lead are identified at step 640; the agent attributes for a particular sales agent are identified at step 650; and a sales activity is identified at step 660. This collection of information is then used at step 670, in conjunction with the correlations previously ascertained at step 620, to derive an estimated probability that a consumer associated with the particular sales lead will transition from one of the consumer states to another of the consumer states in relation to the particular product. Method 600 concludes at step 680 with the publication of the estimated probability. This publication of the estimated probability can occur in a variety of ways that will be readily apparent to one of skill in the art, including through display of the estimated probability on a computer screen, or through the placement of the sales lead in the queue of the particular sales agent.

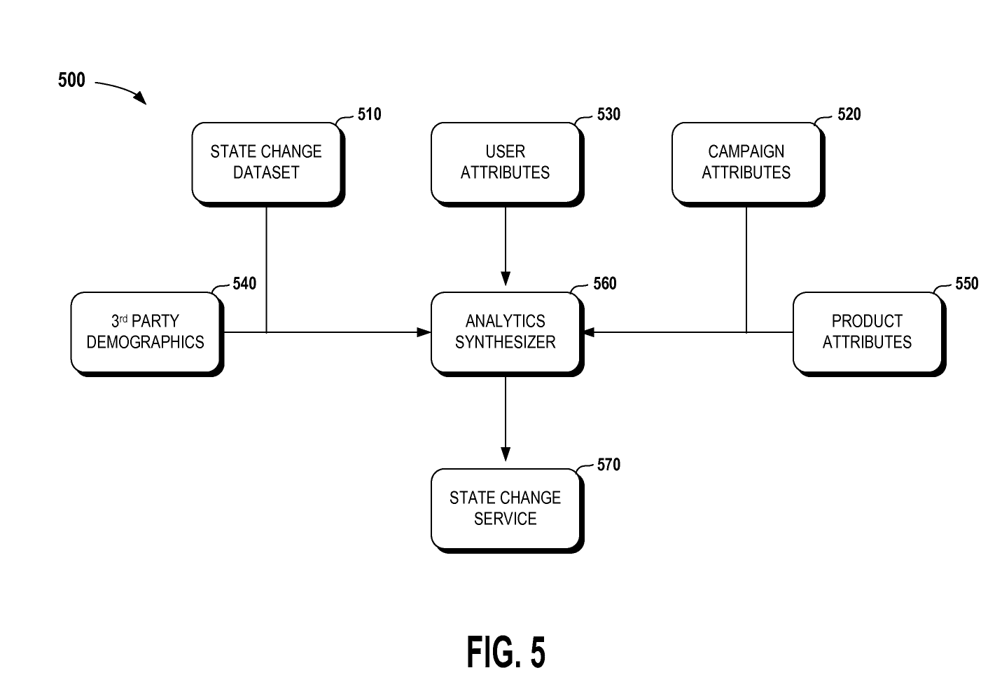

In another illustrative embodiment, a system 500 as shown in FIG. 5 may be used to intersect the profiles likely to transition to an ideal next state and the profiles that progress to other states (e.g. lost opportunity). The system 500 also derives a probability for a particular state transition and correlates related campaign attributes, end-user and user profiles. The system 500 thus demonstrates, by way of example, the analysis of state transitions (e.g. qualified to closed sales) to understand the conditions that triggered the state change and synthesis of the data into independent variables that a system can utilize to predict the likelihood of a state change given a given end-user with a particular profile and interest for a particular product or service. The system 500 consists of a State Change Dataset 510, Campaign Attributes 520, User Attributes 530, 3^{rd} Party Demographics 540, Product Attributes 550, Analytics Synthesizer 560, and State Change Service 570.

The State Change Dataset 510 includes a list of leads (i.e. consumers or businesses with qualified interest for a particular product) that have transitioned from state A to B where A is the start state and B is the end state. This data set includes attributes such as the campaign demographic (e.g. age bracket, retired) and geographic targets (e.g. Southeast) that stimulated the demand, user profiles and end-user profiles. This dataset might look like Table 1.

TABLE 1

| Campaign | User | End-user |
|---|---|---|
| Display and search | Demographic A | Demographic R |
| Southeast | (e.g. age, gender) | (e.g. age, gender) |
| | Category B | Category S |
| | (e.g. MA closer) | (e.g. soccer mom) |

The User Attributes 520 includes a set of users (e.g. sales agents) and their profile attributes. These attributes can include persistent information such as demographics (e.g. age, gender) and objective performance metrics (e.g. closes 80% of MA leads in Southeast). A profile might look like:

User: JDG, Zip: 80503, Gender: Male

Product A close rate for End-user Category R: 80%

Product B close rate for End-user category S: 70%

Product C close rate for End-user category T: 25%

The Campaign Attributes 530 includes the attributes associated with the campaign. This dataset might look like:

Campaign ID: 1234

Region: Southeast

Medium: Web (display, search)

Target: Families with young kids

Demographics: Income $R, DMA zones A, B, and C

Call to action: Click to Call or Chat

The 3^{rd} Party Demographics 540 originates from a third party service compiling various public data sources (e.g. census data) into a useable information source keyed by elements such as a zip code. The system 500 would utilize these datasets to predict or infer demographics for a particular lead opportunity in a particular zip code. For example, the geo information service ESRI predicts segmentation categories, race, gender, income, and home values. The following URL provides an example, expected profile for a lead in zip code 80503: http://www.arcwebservices.com/services/servlet/EBIS_Reports?service Name=FreeZip&zipcode=80503.

The Product Attributes 550 contains product attributes available to particular lead segments. The dataset might contain:

Product ID: 1234

Premium: $R

Feature A: Yes/No

Feature B: Yes/No

Feature C: Yes/No

The Analytics Synthesizer 560 would perform regression analysis for input data to determine the most reliable independent variables to predict probability of closure for a particular state. This prediction probability can take many forms such as an R-squared good fit test. The output of the synthesizer includes an algorithm for a service that responds to queries for state change probabilities and interface requirements (e.g. zip, product interest, campaign ID, state delta) for the State Change Service.

The State Change Service responds to queries for state change probabilities. The service will consume inputs such as a zip code, product interest, campaign ID and state change context and respond with a probability for closure. An example dialogue might be:

Query: 80503, Family Plan, IF001, A->B

Response: Probability R %

A consumer of the service could then use this information to decide whether the allocation of resources should occur given other, relative lead opportunities. For example, all lead opportunities with a 50% probably of closure get queued for processing only when opportunities with a greater probability do not exist or are in a wait state.

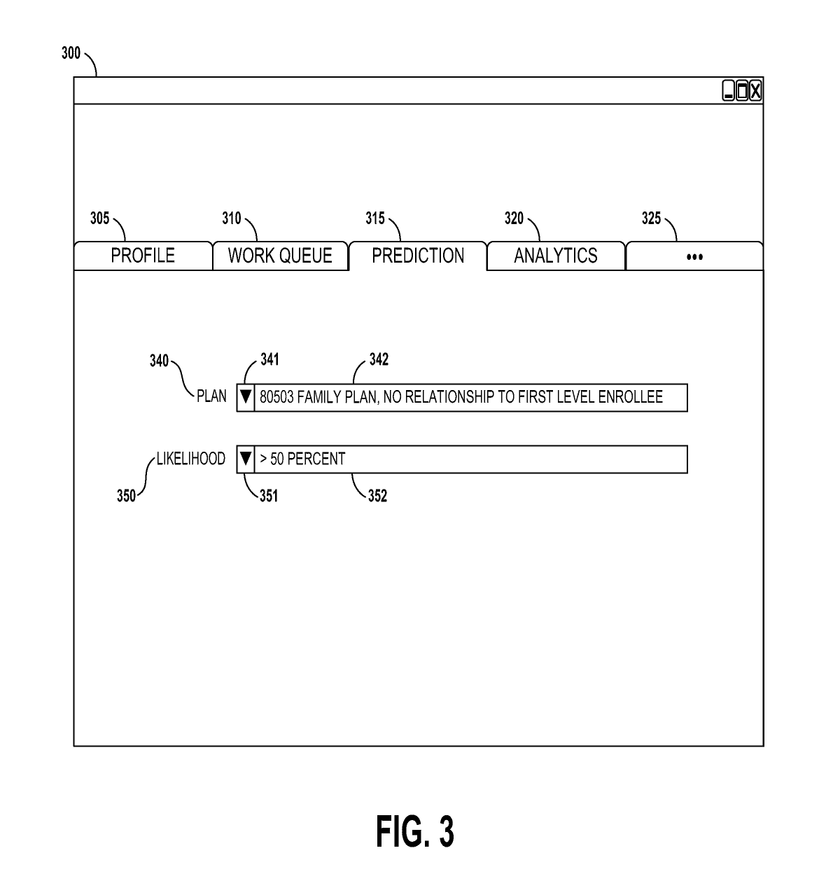

In one example of publishing the results, a sales agent or campaign manager may access the system to queue leads according to the probability to close the sale for a particular product or service as illustrated in FIG. 3—an exemplary user interface 300 serving as the desktop application for a sales agent. The interface includes a number of tabs for various modules including a profile module 305, a work queue module 310, a prediction module 315, an analytics module 320 and a variety of other modules 325 for use by the sales agent. In the window of the prediction module 315, the sales agent may select one of a number of services under the plan heading 340 by accessing a dropdown menu 341 containing a number of combinations of plans and state transitions including a combination entitled “80503 Family Plan, No Relationship to First Level Enrollee”. Based on the attributes of the family plan number 80503, the end user, and the population of sales leads, the correlative process set forth in FIG. 2 derives probabilities of success at step 260. In an embodiment, the user selects a threshold level of success within the prediction module 315, for example, under a likelihood heading 350, by accessing a dropdown menu 351 containing a number of threshold levels including a level 352 entitled “>50 Percent”.

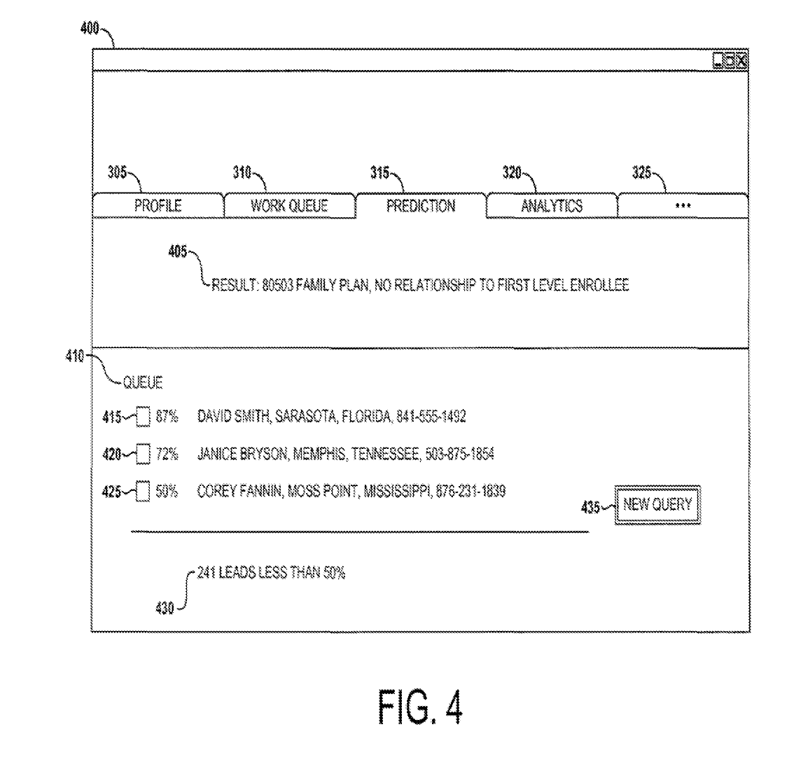

With reference to FIG. 4, in response to the selections made in FIG. 3, the system identifies leads with a probability of closure greater than 50% and presents the qualifying leads in a user interface 400. The query parameters are displayed under a heading 405, and a proposed queue 410 of those leads 415, 420, 425 exceeding the threshold likelihood of success are listed. In embodiments, these leads are simultaneously provided in the sales agents queue. Also, according to the correlations, the ideal activities for engaging with the lead are suggested when the sales agent is engaging with the lead. In other cases, the predictions are consumed by a workflow engine that assigns leads based on the absolute likelihood for a particular sales agent to close a sale or otherwise transition the state of the lead, or the relative likelihood of closing the sale in comparison to other sales agents so that the agent population may be most effectively utilized.

The findings of the process may be used for a variety of other valuable purposes. For example, in formulating the campaign, the correlation process may be used to define the market segments representing the greatest likelihood of success. Specifically, the target demographics and sales tasks and activities can be determined by correlating data of products with similar attributes and, in cases, analyzing the attributes of the sales agents. In one example, the sales tasks and activities will continuously improve by recommending additional products and sales based on the entire set of attributes described herein rather than a simplistic system that merely considers prior sales or one or two core demographics. Other marketing activities may be modified depending on the results including the triggering events (display, search, voice, mailings) and points of contact (toll free number, chart URI, website URL, etc.).

In other embodiments, the system and method will provide campaign managers with better views into the impact of the campaign by analyzing individual transitions from one state to another based on the initial state of the lead rather than merely close rates. By analyzing the data at this level, lead populations having composite initial states with a disproportionate number of immature or mature leads will not improperly skew the analysis of the effectiveness and value of the sales activities. Likewise, in other embodiments, the systems and methods of the present invention will allow campaign managers to predict the likelihood of ultimately closing a sale based on the transition from earlier states in the sales process for like consumers.

Also, the correlations may be used to prioritize resource allocation between and among campaigns, products and market segments. In embodiments, the probability for closing a lead is further enriched by the short term and lifecycle value of closing the lead to evaluate the total expected return on investment. In other embodiments, the system and method of embodiments of the present invention is employed to determine the skill-based attributes of the sales agents most impactful on closing, and may be used for recruitment of certain sales agents to certain campaigns. Likewise, the system and method may be employed to sample and value whether additional data sources (and the cost associated with obtaining rights and infrastructure to access such sources) are justified in positive sales outcomes.

Additionally, as additional market segments are identified through the improvement of campaign targeting, user attributes will be enriched. For example, in embodiments, the sales agent attributes are further stratified to include close rates for products across more targeted segments than the initial data set.

In conclusion, the present invention provides, among other things, a system and method for advancing marketing opportunities to sales. Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. Many variations, modifications, and alternative constructions fall within the scope and spirit of the disclosed invention.

What is claimed is:

1. A system for promoting conversion of sales leads into completed sales, the system comprising:
at least one processor; and
a memory connected with the at least one processor, the memory containing a plurality of program instructions configured to cause the at least one processor to:
identify a plurality of consumer states, each consumer state in the plurality of consumer states corresponding to a particular situation in a sales lifecycle, a particular one of the plurality of consumer states corresponding to a completed sale;
ascertain one or more correlations among historical sales-lead attributes, product attributes, sales-agent attributes, sales activities, and consumer state transitions;
identify a particular product having a particular set of product attributes;
identify a particular sales lead having a particular set of lead attributes;
identify a particular sales agent having a particular set of agent attributes;
identify one or more particular sales activities; and
derive, based on application of the one or more correlations to the particular set of product attributes, the particular set of agent attributes, the particular set of lead attributes, and the one or more particular sales activities, an estimated probability that a consumer associated with the particular sales lead will transition from one of the plurality of consumer states to another of the plurality of consumer states in relation to the product.

2. The system of claim 1, wherein the one or more correlations among historical sales-lead attributes, product attributes, sales-agent attributes, sales activities, and consumer state transitions are ascertained through a regression analysis.

3. The system of claim 2, wherein the consumer state transitions are dependent variables in the regression analysis.

4. The system of claim 2, wherein the validity of the regression analysis is evaluated using an R-squared goodness of fit analysis.

5. The system of claim 1, wherein the historical sales-lead attributes and the particular set of lead attributes include at least one of a lead identifier, a lead phone number, a lead gender, a lead age, a lead geographic location, a lead language preference, a lead product of interest, and a preferred lead contact time.

6. The system of claim 1, wherein the product attributes and the particular set of product attributes include at least one of a product identifier, a product price, a product price range, and a product feature.

7. The system of claim 1, wherein the sales-agent attributes and the particular set of agent attributes include at least one of an agent identifier, an agent ZIP code, an agent gender, and an agent historical consumer state transition rate.

8. The system of claim 1, wherein the sales activities and the one or more particular sales activities are associated with one or more marketing invitations for triggering a response from a consumer and one or more points of contact by which a consumer can respond to the one or more marketing invitations.

9. The system of claim 1, wherein the plurality of program instructions are further configured to cause the at least one processor to:
ascertain one or more correlations among historical sales-lead attributes, product attributes, sales-agent attributes, sales activities, consumer state transitions, and activities for engaging with sales-leads;
identify one or more activities for engaging with the particular sales lead; and
identify a particular activity for engaging with the particular sales lead that results in a higher estimated probability that a consumer associated with the particular sales lead will transition from one of the plurality of consumer states to another of the plurality of consumer states in relation to the product than another activity for engaging with the particular sales lead.

10. The system of claim 1, wherein the plurality of program instructions are further configured to cause the at least one processor to assign the particular sales lead to a particular sales agent based on the estimated probability.

11. The system of claim 1, wherein the plurality of program instructions are further configured to cause the at least one processor to derive, based on application of the one or more correlations to the particular set of product attributes, the particular set of agent attributes, the particular set of lead attributes, and the one or more particular sales activities, an estimated probability that a consumer associated with the particular sales lead will, in relation to the product, transition from one of the plurality of consumer states to the particular one of the plurality of consumer states that corresponds to a completed sale.

12. The system of claim 1, wherein at least one attribute of the particular set of lead attributes is identified by accessing a third-party database.

13. A method for promoting conversion of sales leads into completed sales, the method comprising the steps of:
identifying in a computer memory a plurality of consumer states, each consumer state in the plurality of consumer states corresponding to a particular situation in a sales lifecycle, a particular one of the plurality of consumer states corresponding to a completed sale;
using at least one processor connected with the computer memory to ascertain one or more correlations among historical sales-lead attributes, product attributes, sales-agent attributes, sales activities, and consumer state transitions;
identifying in the computer memory a particular set of product attributes for a particular product;
identifying in the computer memory a particular set of lead attributes for a particular sales lead;
identifying in the computer memory a particular set of agent attributes for a particular sales agent;
identifying in the computer memory one or more particular sales activities;
using the at least one processor to derive, based on application of the one or more correlations to the particular set of product attributes, the particular set of agent attributes, the particular set of lead attributes, and the one or more particular sales activities, an estimated probability that a consumer associated with the particular sales lead will transition from one of the plurality of consumer states to another of the plurality of consumer states in relation to the product; and
publishing the estimated probability.

14. The method of claim 13, wherein the one or more correlations among historical sales-lead attributes, product attributes, sales-agent attributes, sales activities, and consumer state transitions are ascertained through a regression analysis.

15. The method of claim 14, wherein the consumer state transitions are dependent variables in the regression analysis.

16. The method of claim 13, further comprising:
using the at least one processor connected with the computer memory to ascertain one or more correlations among historical sales-lead attributes, product attributes, sales-agent attributes, sales activities, consumer state transitions, and activities for engaging with sales-leads;
identifying in the computer memory one or more activities for engaging with the particular sales lead; and
using the at least one processor to identify a particular activity for engaging with the particular sales lead that results in a higher estimated probability that a consumer associated with the particular sales lead will transition from one of the plurality of consumer states to another of the plurality of consumer states in relation to the product than does another activity for engaging with the particular sales lead.

17. The method of claim 13, further comprising assigning the particular sales lead to a particular sales agent based on the estimated probability.

18. The method of claim 13, further comprising using the at least one processor to derive, based on application of the one or more correlations to the particular set of product attributes, the particular set of agent attributes, the particular set of lead attributes, and the one or more particular sales activities, an estimated probability that a consumer associated with the particular sales lead will, in relation to the product, transition from one of the plurality of consumer states to the particular one of the plurality of consumer states that corresponds to a completed sale.

19. The method of claim 13, wherein at least one attribute of the particular set of lead attributes is identified by accessing a third-party database.

20. A computer-readable storage medium containing a plurality of program instructions for execution by a processor, the plurality of program instructions being configured to:
identify a plurality of consumer states, each consumer state in the plurality of consumer states corresponding to a particular situation in a sales lifecycle, a particular one of the plurality of consumer states corresponding to a completed sale;
ascertain, through a regression analysis, one or more correlations among historical sales-lead attributes, product attributes, sales-agent attributes, sales activities, and consumer state transitions;
identify a particular set of product attributes for a particular product;
identify a particular set of lead attributes for a particular sales lead;
identify a particular set of agent attributes for a particular sales agent;
identify in the memory one or more particular sales activities; and
derive, based on application of the one or more correlations to the particular set of product attributes, the particular set of agent attributes, the particular set of lead attributes, and the one or more particular sales activities, an estimated probability that a consumer associated with the particular sales lead will transition from one of the plurality of consumer states to another of the plurality of consumer states in relation to the product.
